(19) United States
(12) Patent Application Publication
(10) Pub. No.: US 2014/0289445 A1
(43) Pub. Date: Sep. 25, 2014

(54) HARDWARE ACCELERATOR SYSTEM AND METHOD

(71) Applicant: Antony SAVICH, Guelph (CA)

(72) Inventor: Antony SAVICH, Guelph (CA)

(21) Appl. No.: 14/223,363

(22) Filed: Mar. 24, 2014

Related U.S. Application Data
(60) Provisional application No. 61/804,391, filed on Mar. 22, 2013.

(51) Int. Cl. G06F 13/40

(52) U.S. Cl. CPC G06F 13/4022
USPC 710/317

(57) ABSTRACT

There is provided a hardware accelerator system and method. The system and method relate to a low power scalable stream compute accelerator for general matrix multiply (GEMM). There is provided a systolic compute accelerator architecture for matrix operations. Further, the system may include an application specific engine.

### CROSS REFERENCE TO RELATED APPLICATIONS

This application claims the benefit of priority of U.S. Provisional Patent Application No. 61/804,391, filed Mar. 22, 2013, which is incorporated herein by reference.

### FIELD

The present disclosure relates generally to a hardware accelerator system and method. More particularly, the present disclosure relates to a low power scalable stream compute accelerator for general matrix multiply (GEMM).

### BACKGROUND

Many applications, ranging from machine learning, image processing, machine vision to optimization, utilize matrix multiplication as a fundamental block. Matrix operations play an important role in determining the performance of such applications.

Matrix manipulation operations are crucial steps in many types of applications ranging from machine learning techniques such as Artificial Neural Networks, to image and signal processing. One of the most fundamental actions within these algorithms is matrix multiplication. The complexity of matrix multiplication is generally described as O(N³) where N is the dimension of a square matrix. Accordingly, it requires substantial computing power especially when the matrices are quite large such as in medical imaging, 3-D image manipulation or even in complex optimization problems that require solving a set of linear equations.

Traditional Von Neumann architectures may suffer from a bottleneck limiting the effective processing speed when the CPU is required to perform number crunching on large amounts of data. This can be attributed to the sharing of the bus between the program memory and data memory. Improving the performance of the computer system can be achieved by exploiting parallelism in the form of spatial and temporal techniques. Temporal parallelism tends to use multi-stage pipelining to partition the application into several phases that can run simultaneously. Spatial parallelism on the other hand tends to use multiple cores, duplicated functional units and multiprocessors to achieve speedup.

The right balance between data flow and computational resources is essential in highly parallel systems.

Therefore there is a need for an improved hardware accelerator system and method to address at least one disadvantages of previous architectures.

### SUMMARY

According to an aspect, there is provided a hardware accelerator system.

In a particular case, there is provided a systolic compute accelerator architecture for matrix operations.

In another particular case, the interface may consist at the minimum of 1 input and 1 output ports (or 1 bi-directional port) with adapters to the 4 communication streams.

In still another particular case, there is provided a multicore/multichip capability.

In yet another particular case, the system may include an application specific engine. In some cases, the ASE is intended to allow for in-stream computations of a variety of functions without loss of time and with minimal hardware added.

In still another cause, the system may provided for specific hardware components in the Processing elements and mini Processing Elements which may provide for “on the fly” transverse operand operations.

According to another aspect, there is provided a hardware accelerator method.

### BRIEF DESCRIPTION OF THE DRAWINGS

Embodiments of the present disclosure will now be described, by way of example only, with reference to the attached Figures.

FIG. 1 is an embodiment of a hardware accelerator system;

FIG. 2 illustrates a structure of a mini processing element;

FIG. 3 illustrates a structure of a processing element;

FIG. 4 illustrates an arrangement of processing elements in a systolic array;

FIG. 5 illustrates a single core embodiment;

FIG. 6 is a graph illustrating the effect of revisions on performance;

FIG. 7 is a neural network functional block; and

FIG. 8 illustrates core attachment in Multi-core/multichip configurations.

### DETAILED DESCRIPTION

In the following disclosure the architecture of both the compute core and the fully functional prototype system will be explained in detail. This disclosure proposes an efficient hardware accelerator. The proposed architecture is general enough so as to be efficiently utilized in any application incorporating matrix-matrix or matrix-vector multiplication. The proposed architecture is scalable; it is capable of operating on smallest to largest devices, single or multiple FPGAs. In certain cases, the accelerator may be implemented on ASIC chips or multi-purpose general processors as a standard accelerator component. The proposed design may also provide power and energy tradeoffs. The system may consume less power than conventional general purpose processors which allows it to be used as an embedded system. This disclosure is intended to address performance, scalability and power at the same time.

Without limiting the scope of the invention, the accelerator can also be implemented on ASIC chips or multi-purpose general processors as a standard accelerator component.

Two recurrent themes emerge in development of hardware accelerator system and methods. The first theme is based on assumptions (simulation) vs. real system considerations (actual implementation). The attachment and overall system design play a significant role in achieving targeted performance and scalability including considering it in developing new proposed architectures and utilizing functional prototypes in improvement and comparisons. The second theme is power consumption, important for systems targeting embedded reconfigurable applications.

Fine grain scalability is one of the main themes desired. In order to accomplish this goal, an architecture needs to be adaptable to the resources available in the target platform, in this case an FPGA. A variable number of processing elements are required to manipulate data, and this number should optimally change in unit increments to achieve best resource utilization and performance efficiency. At the same time, the I/O interface is the typical bottleneck of most if not all high performance GEMM as well as other compute accelerators. The external I/O interface is highly important to consider, and in the case of the embodiments described herein, the architecture is built from the attachment system and interface inwards. A stream based Dataflow architecture is chosen.

The I/O ports for a single core, composed of multiple processing elements, are represented with few unidirectional data streams. The processing elements inside the core are systolically attached, allowing the fine architecture granularity and high data reuse within an application. This approach performs well in many applications, including GEMM.

Using this simple unified general purpose I/O approach, system scalability is further exploited by matching attachment system's I/O capabilities to the algorithm computational granularity to achieve enhanced performance using minimal resources. In systems with limited data I/O, a single small or large core can compute larger data sets efficiently.

On the other hand, in systems capable of sustaining multiple I/O stream attachments, multiple heterogeneous cores can perform a wide range of operations, from large to tiny, with high utilization efficiency. Multi-chip multicore system configurations are achievable for best performance and flexibility.

The core is also scalable in the representation of data, where operand arithmetic representation is a fully parameterized value. The data can be represented using fixed or floating point formats, which may change the type of underlying hardware blocks used. The bit widths of the representation, fixed or floating point, can also be modified at synthesis time, and can be different for each argument and intermediate value in computation.

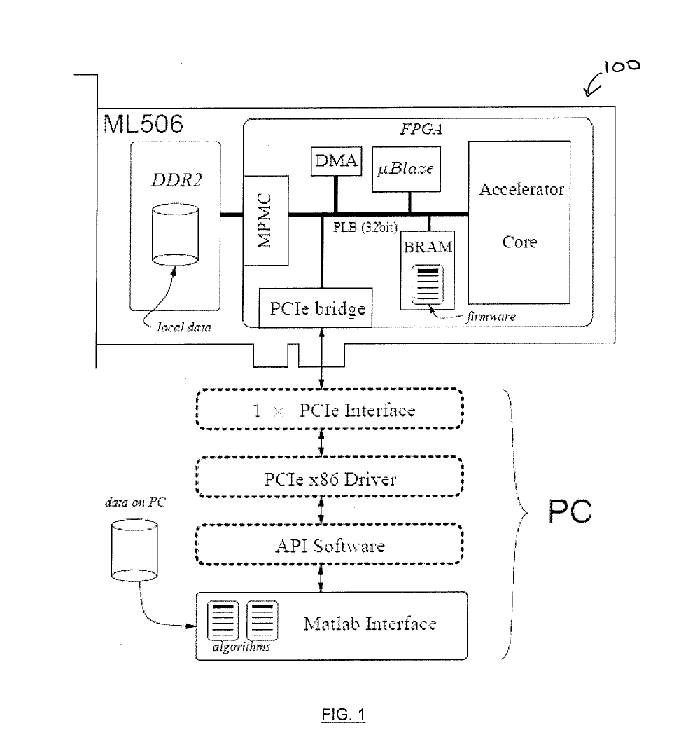

An embodiment of a system 100 architecture is illustrated in FIG. 1. In this embodiment. Matlab 2010b is used as the interface to the accelerator. Matlab employs vendor specific BLAS libraries to attain top GEMM speed for measuring CPU performance, and provides a uniform verification and benchmarking platform for the FPGA board. API software is developed to interface between Matlab and the PCIe driver for the accelerator. It is used to transfer data and control operations over a 1×PCIe link to the Xilinx ML506 board (as detailed herein). The accelerator platform is intended to perform computations on any size data using any compute core configuration. It is generally limited only by the size of the DDR2 SODIMM selected. The board is currently fitted with 256 Mb DDR2-400 RAM.

The accelerator can also perform computation on data in PC's memory directly, being limited by the size of PC memory hierarchy. This approach is not used since accelerator run-time I/O requirements exceed the bandwidth of the 1_{┐} PCIe interface provided by the ML506.

It may be noted that the choice of a PCIe attachment interface and a Matlab API is based solely on the simplicity of experimental setup. Same data sets can be used in generating both PC performance and FPGA results. The results of both computations can then easily be compared using the same tool chain for validation and numerical accuracy. The real target for the FPGA architecture proposed here is low power embedded applications requiring high performance matrix computation acceleration. Other choices of attachment interfaces range from GigE/10 GE for remote data storage to direct connection with live sources of data, such as cameras and sensors. The FPGA system implemented in this work to demonstrate the proposed architecture is independent of the PC in itself, and can be used entirely without it. The on-board MCU and software are self-sufficient and allow for completely independent operation regardless of the source of data for computation.

In certain cases, the system may function as a standalone system, in single or multiple FPGA mode, with communication to the system facilitated through means other than PCIe, for example, GigE Ethernet, a variety of other serial communication modes, and direct connection of data source devices, such as image and video cameras and other sensors directly to the system.

The internal architecture is presented bottom-up in this section. Table 1 lists the notation used in the figures that follow. Z=αXY+βW is used as an illustration, where and are scalars and all other operands are matrices. A (′) represents a partial result, e.g. Z′ is the partial product of an incomplete block operation X′Y′.

The accelerator adopts a dataflow architecture. Most control functions are driven by the data flow itself. Computations on matrices are performed in blocks, and the blocks are further subdivided into sequences of rows or columns. The inputs are pushed into several input chains connected via the stream input ports. The data is presented to each processing element in the chain in succession. The processing elements use the data values flashed on their inputs in the chain together with values stored in their local caches to compute required operations. When results are formed, they are either stored back into local caches for further processing, or flashed onto the output chains, which are then streamed sequentially out of the accelerator. The seemingly sequential nature of I/O interaction with the core significantly simplifies and relieves bandwidth requirements to get the data to and from the accelerator, while at the same time allows for highly scalable parallelization of computation on many data elements simultaneously by arrays of simple processors.

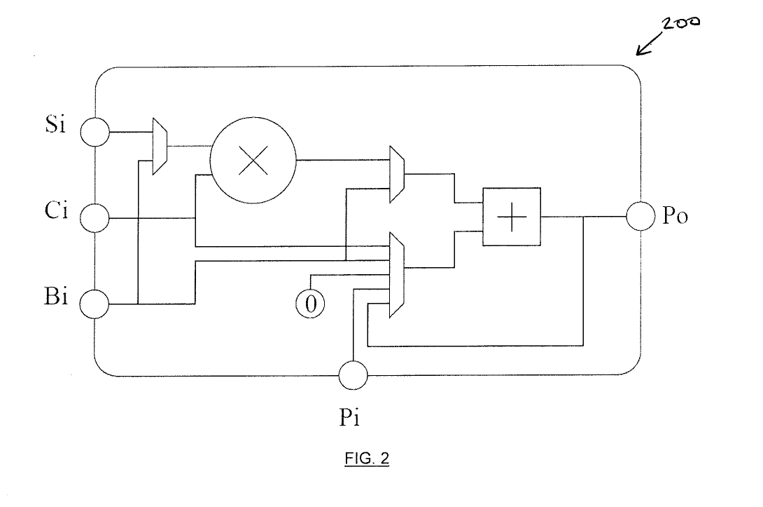

At the lowest level of hierarchy, the structure of a mini processing element (mPE) 200 is demonstrated in FIG. 2. It contains all basic hardware necessary to perform GEMM effectively. The extra pathways, such as a Pi-Po stream, give an I/O efficiency improvement by enabling in-stream selection of Z=XY or Z=X^{T}Y operators. Operand row-order in memory is maintained, and an extra row-column reorganization step is eliminated by in-stream selection of compute pathways (same PE accumulation or PE-PE transfer accumulation).

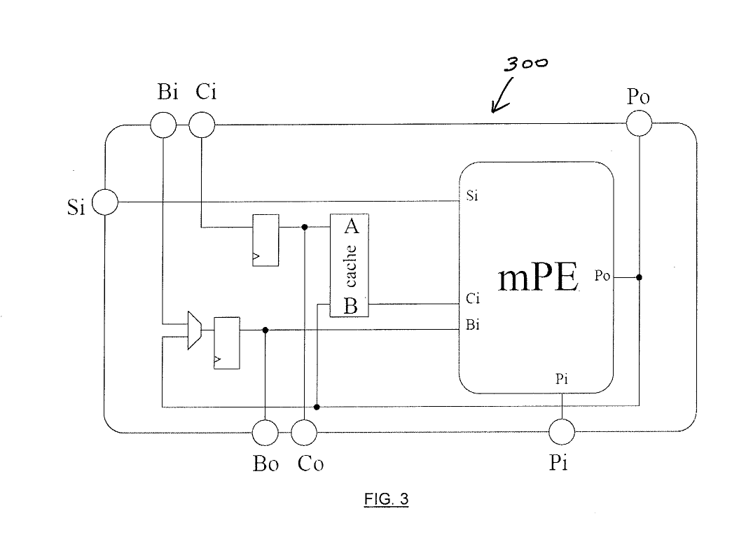

The mPE is combined with cache and stream interfaces to form the processing element (PE) 300, as shown in FIG. 3.

In some cases, a GEMM operation would involve the following steps:

1. Prefetch cache via C stream with a block of matrix Y

2. Preload W, α, β, or Z′ to stream B if necessary

3. Stream blocks of X via S, compute result in-stream

4. Latch elements of Z to stream B (or cache)

5. Offload data from B if necessary

In other cases, a GEMM Z=αXY+βW operation would involve the following steps:

```
  divide X and Y into blocks X′ and Y ′ of size (PE ×
  cache depth);
  for each block of X′ and Y ′ do
    prefetch Y ′ into cache via stream C;
    preload any W, , 3 or Z′ to stream B;
    for each row of X do
      stream new elements of the row of X′ via S;
      multiply-accumulate elements of X′ and Y′
      across PEs;
      if Z′ contains final elements of XY then
        shift new partial results of Z′ from PEs
        via P;
        perform scalar operations using , 3 and
        W at output of P and B via ASE (§3.3) ;
      else
        shift new elements of Z′ from PEs via P
        to memory or cache;
      end
    end
end
```

The degree of parallelization among the operating steps is variable and depends on the size of the PE array available in the core. The time complexity of the matrix multiplication is O(nmp/PE), where the matrix sizes of the operands are n×m and m×p, and PE is the number of processing elements available in the core.

The auxiliary stream (B) is used for both loading partial products, performing auxiliary scalar or element-wise operations, or offloading full or partial results from the accelerator. The preload and offload operations on this stream can be performed simultaneously, reducing the number of I/O ports, stream registers, and total I/O cycles.

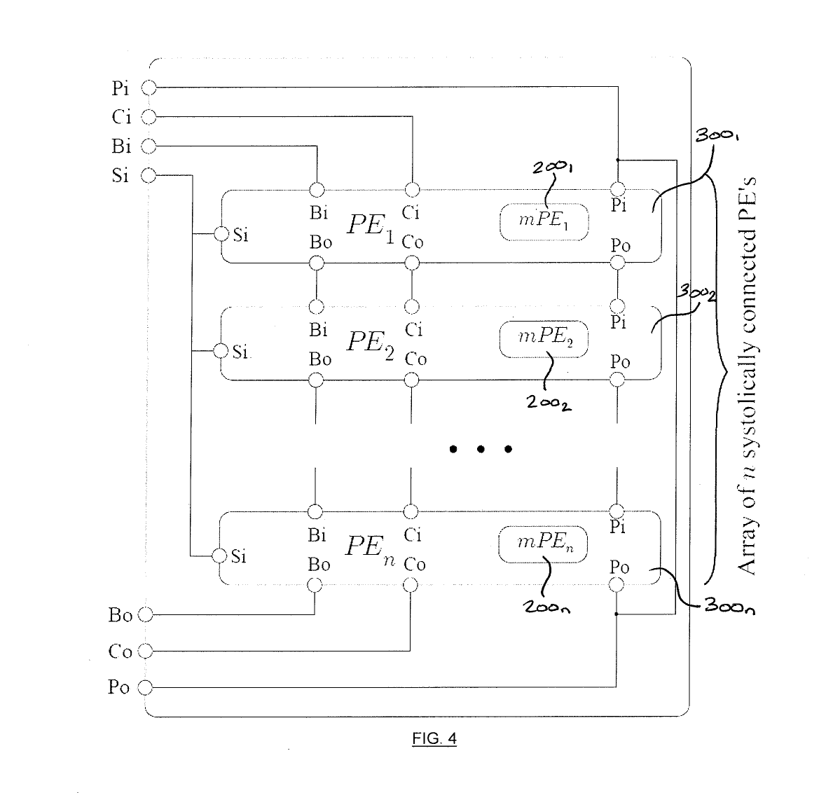

The PEs are arranged in a systolic array to form the basis for the compute core, as demonstrated in FIG. 4. A single core contains one stream attachment interface (to any standard bus), a control block and queue, and a systolic PE array. In some cases prototype, a PLB attachment is used.

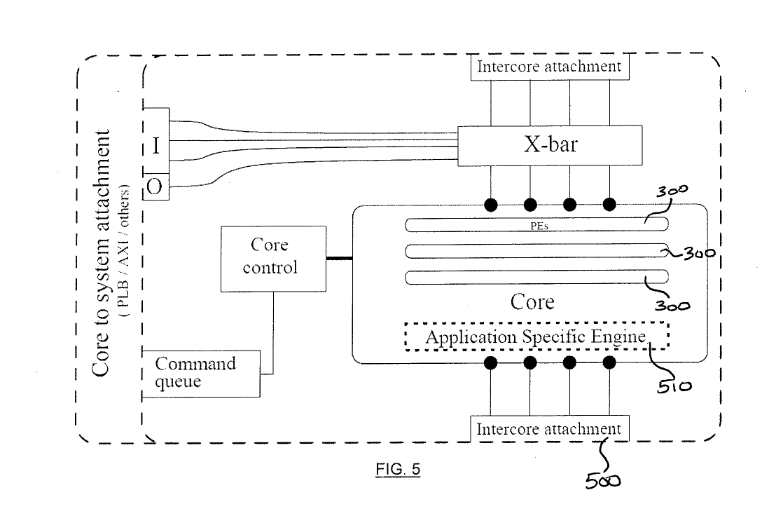

FIG. 5 illustrates an embodiment with a single core 500. The PE array has an application specific engine (ASE) 510 attached in-stream, as seen in FIG. 5. The ASE is configurable to perform any scalar, element wise, or benchmarking operations directly in hardware concurrently to a GEMM operation in progress. This ability packs many non-compute but I/O intensive operations concurrently with high I/O and high computation core functions in-stream. By analyzing target applications, sets of GEMM and any number of related auxiliary operations can easily be extracted and grouped. The basic configuration supporting the Z=αXY+βW operation is demonstrated in FIG. 4 (as a simple case). The ASE allows performing any group (GEMM+AUX) as a single operation in the core, reducing total computation time and I/O bandwidth requirements significantly. In many algorithms, all arithmetic operations can in fact be decomposed into such groups. Computational performance in such cases is equal to that of the underlying matrix operations, with auxiliary computation and bandwidth overhead effectively hidden.

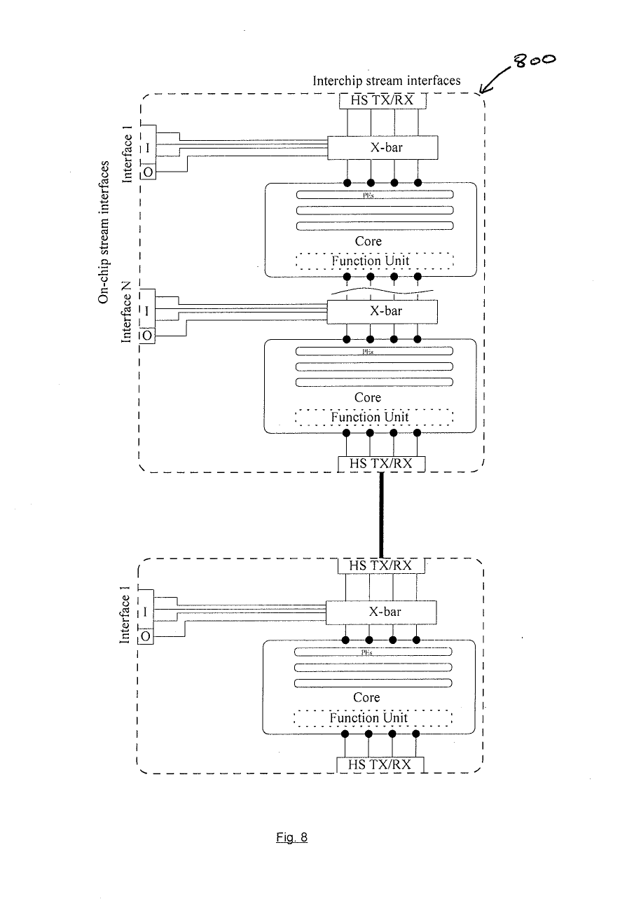

The same attachment interface, as is illustrated in FIG. 5, can be used at run-time to connect multiple cores together, forming a chain or star topology of systolic arrays, as demonstrated in FIG. 8. There is generally no advantage in using multiple stream interfaces per core, since a single stream interface per core is considered sufficient for full utilization. However, in systems where available I/O bandwidth is high, and multiple stream ports can be used, there may be an advantage in implementing multiple cores. A heterogeneous PE configuration or architecture enhances computational efficiency where small and large matrices can be computed in parallel, each on a core of most efficient size for the underlying data set. Multiple small matrix/vector operations can be performed concurrently on multiple small size cores, increasing parallelism scalability. For large data operations at various algorithm steps, multiple cores can be connected together on the fly, whether such cores reside on one or multiple FPGAs, to facilitate high data reuse and boost available parallelism and hence performance on such large sets.

This work demonstrates a functional dense matrix compute architecture and prototype. Sparse matrix computation also plays a significant role in important algorithms. Sparse matrix computation performance is highly dependent on the compatibility of the compute architecture with the data representation format. The stream architecture presented here is well positioned for acceleration of sparse matrix computation with in-stream sparse format processing modules. The proposed system may move from a dense-only to sparse/dense matrix computation capability within a unified architecture. This is of significance as many algorithms typically require both dense and sparse matrix operators that can benefit from acceleration. The typical case is to implement two separate custom cores or processors to perform each type of operation separately, with only half resources per each core achieving half of potential performance. Using a unified compute core may significantly improve resource utilization and flexibility, as well as boost overall performance.

A comparison between the proposed FPGA system and a full featured PC is made in this section. The FPGA system is mapped to the Xilinx ML506 board with XC5VSX50 FPGA manufactured using 60 nm silicon process and having 288 DSP blocks, 264 18 Kb Block RAMs, 8,160 slices, 256 Mb external DDR2-400 RAM, and 1×PCIe port. The PC system used is a Dell T7500 workstation, with 2 Gb DDR3-1333 RAM, and a quad core Intel Xeon E5405 2 Ghz processor with 2×6 Mb L2 cache manufactured using 45 nm silicon process.

Results were obtained based on an FPGA system that is configured with a single 204 PE core, a PLB attachment, a single 32 bit Xilinx PLB DMA controller, a MicroBlaze MCU, 1 lane PCIe to PLB bridge, and one PLB to DDR2 memory controller (MPMC) port. The core is configured to use a 16 bit wide fixed point 1-3-12 arithmetic representation, giving [−2³; 2³) range and 2⁻¹² uniform precision across all hardware channels for simplicity. A full precision accumulator, in this case 32 bits wide, is used to eliminate accumulation errors (only data conversion and result truncation errors are present). This representation is adequate for many algorithms. Larger representations, up to 18 bits wide for cache stored multiplicands, and 25 bits for streamed multiplicands and partial products, with appropriate lossless accumulators, are feasible with a negligible increase in resource consumption on the same FPGA. The Virtex 5 FPGA contains 18×25 hard DSP blocks, and 18 bit wide Block RAMs in the correct BRAM-DSP proportions, so that one BRAM-DSP pair is used per PE. Wider fixed point and floating point representations require multiple BRAM-DSP pairs per one PE. The effects of larger representations on resource consumption and performance reduction due to lower PE count may be considered.

In all comparisons, the PC's task load outside of the computation at hand was minimized by stopping all nonessential services and processes, to eliminate distortion of results from any non-related computation. The idle workload, before and after tests, was negligible at below 1%.

Power is an important part of this comparison. Hence, the findings demonstrate that the FPGA embedded platform significantly outperforms the PC. Table 2 summarizes the results. Not only is the up-front power dissipation greatly reduced by performing computation on FPGA at similar performance levels, but the form factor is also a significant advantage. Taking advantage of the flexibility and scalability of the accelerator architecture presented here, large scale high performance implementations can be implemented at the embedded scale, independent of the PC.

The power measurements are obtained for the PC by measuring the total power input at the mains (P=VA), and for FPGA at the board power input. Unfortunately there is no facility to measure individual FPGA power rail consumption on the ML506. FPGA power reported is a board level measurement. Even though the FPGA board is connected to the PC via the PCIe bus, it draws no power from the PC via that interface. The only associated power connection with the PCIe interface is in the signal drivers, with power attribution negligible.

The PC, when idle, consumes 117.4 W of power (with no FPGA board). In comparison, the FPGA board consumes 5.7 W when being configured (peripheral device clock nets are down), 10.26 W when configured and MCU not running, and 10.4 W when MCU is running awaiting operations. The FPGA board consumes 11.07 W in full computation, at approximately 1:5 system to clock ratio (core clock is gated) to achieve similar performance with PC consuming 164.8 W. When comparing energy consumed per unit of computation (J/GMAC), the FPGA is 36× more energy efficient vs. PC, not including overhead. This result demonstrates the suitability of the proposed architecture in embedded systems, giving no sacrifice to a wide application range while maintaining excellent performance.

A number of datasets are selected to report system performance and compare it to the performance of the PC, Results are listed in Table 3. It should be noted that the performance currently achieved by the FPGA system is nearly that of the PC. Yet the emphasis of this work is to produce a low-power, highly scalable and high performance compute core targeting small for factor embedded systems. A straight 10× improvement can be achieved by replacing the stock Xilinx 32 bit DMA controller with an efficient alternative.

Performance is measured in Giga Multiply Accumulates per Second (GMACS). 1 GMACS is equivalent to 2 GFLOPS when using floating point arithmetic, and 2 GIOPS (Giga Integer Operations Per Second) when using fixed point arithmetic. The best and worst performance are highlighted in bold. The core clock is gated to compensate for the inefficiencies of the Xilinx supplied DMA mechanism. In the current best case, the core is clocked once (1 word of data available) per every 5 system cycles. The worst ratio on this dataset is 7.

The performance listed in Table 3 is achieved with a single 204 PE core using an inefficient DMA controller for streaming the data. All system components have been optimized to operate at 200 MHz. A basic DMA block is used to pump data from on-chip memory controller to the stream core via the 200 MHz 32 bit PLB bus. The DMA controller used is the standard PLB DMA IP core provided by Xilinx in EDK 12.4 suite. It can transfer only 32 bit words of data per bus cycle, thus wider bus configurations are not effective. It is a half duplex core supporting 16 word burst transfers, and in testing achieves only 1 word transferred per 5 bus cycles this explains the 1:5 system to core ratio. This roughly translates to a bandwidth of approximately 200 Mb/s or 50 Mwords/s. The memory controller and on-board DDR2 is capable of 3.2 Gb/s bandwidth. Core frequency and vendor dependent optimizations were not the emphasis of this work, as the limiting factor is this attachment system. Nevertheless, the core itself without an attachment interface can operate at 345 MHz (synthesis estimate) on the currently used FPGA without any optimization. Based on the simplicity of design, the fact that all critical path components reside in the mPE (which has been designed to fit completely within hard DSP slices), there is no doubt that a vendor specific optimization will achieve the advertised 550 MHz barrier. XST synthesizer from Xilinx is not able to interpret any vendor independent VHDL code of reasonable functional complexity cleanly into DSP slices at this time. At this frequency, and assuming an improved DMA engine, the core can achieve performance between 19.5-89.1 GMACS (equivalent to 39-178 GIOPS) on the current board. This chip's absolute maximum estimated performance, given no attachment overheads and other system constraints (thus increasing PE count to 288 and using 4 independent stream engines) in a “perfect” simulated system is 158 GMACS or 316 GIOPS, a 12× improvement over the 4 core PC.

Given the current core implementation, and ignoring an inefficient DMA engine and vendor independent VHDL to hardware mapping, Table 3 also lists the acceleration of the core of the PC using a 0.5 system to core ratio (400 MHz) assuming an upgraded DMA controller. The result of simply substituting an appropriate DMA controller vs. stock Xilinx offering is an acceleration of 4.3-6.8× over the PC at a core clock frequency five times slower than that of the PC. The theoretical performance improvement of FPGA vs. this PC can be re-estimated at 30-40× when considering the largest Virtex5 device (sx240t). It would be a fair comparison, as the Xeon processor used here is of the largest in the series of this vintage, and is manufactured using 45 nm technology vs. 65 nm for the FPGA. However, the emphasis of this paper is on real results of performance and most notably power efficiency in equivalent vintage and cost systems, and not on estimates.

Resource consumption is directly proportional to performance gain. In designs where PEs consume more resources, a smaller percentage can be placed using the same footprint, thus reducing performance density. Because this work is proven using a fully functional prototype, and not simply simulations and estimates, effects of attachment system components need to be considered. The design choice of a particular attachment system can make a difference in the final device performance, as is illustrated here. Table 4 shows resource consumption by PE, core and system, based on the current mapping using a maximum number of PEs for a PCIe based system on a Xilinx ML506 board.

Where the synthesizer, as is typically reported in simulation-based works, uses a certain number of LUTs and FFs below the device capacity, a design can still easily fail placement on a real system. Routing constraints, contrasting control sets, and timing expectations must be carefully considered to make sure a design is actually feasible. In Table 4, this point is clearly demonstrated with the core using only 32% of LUTs and 22% of FFs, but more than 42% of available Slices (4 LUT-FF pairs on Virtex 5 devices) because some LUTs and FFs cannot be paired. Further, the final system uses 97% of all available Slices on the chip. In this design, the remainder of Slices are occupied by the MicroBlaze MCU (^{˜}5%), DDR2 Memory Controller or MPMC (^{˜}15%), and PCIe-PLB Bridge (^{˜}30%). Approximately 30 36 Kbit BRAMs are used by the system in the MicroBlaze and operating memory. Operating memory that is used to store the core and system drivers and firmware can be placed in off-chip SRAM. This, however, does not free up a significant amount of resources in comparison, as an additional SRAM controller may occupy scarce Slices and may reduce the maximum number of PEs placeable.

The system performance is directly proportional to the available resources on the chip. The hardware cost complexity consists of system overhead and core components. System overhead is approximately 4.5 k slices, 30 BRAMs, and 3 DSP. The overhead configurable resources (slices) are taken up primarily by the multiport DDR memory controller and the PCIe interface hardware. The BRAMs are used for the on-chip memory, which contains the required software to drive the accelerator board and communicate with the PC. 3 DSPs are used in the MCU. The core consumes approx. 17 slices, 1 DSP, and 0.5 BRAM per PE. Given the 6.5 GMACS actual (at 5:1 system to core clock ratio), and 65 GMACS DMA upgraded (at 1:2 system to core clock ratio) performance for the 204 PE system, this results in the consumption of 530(53) Slices, 31(3) DSP, 16(1.6) BRAMs per each 1 GMACS of actual (upgraded) performance required. The consumption is nearly linear with the computation of matrices of any size larger than the number of PE's in the system. This result is fairly straight forward as it becomes inefficient to use a long systolic array for computation of small matrices. Special data paths can be added to masquerade a long systolic array as a short one to improve efficiency, but a better solution is to use a heterogenous muticore architecture where a variety of array sizes can simultaneously provide improved performance in two dimensions: by improving efficiency of smaller matrix computations in each core, and at the same time performing multiple small matrix operations in parallel. The smaller cores can then be linked together into a large array on the fly to compute large matrix operations with maximum performance.

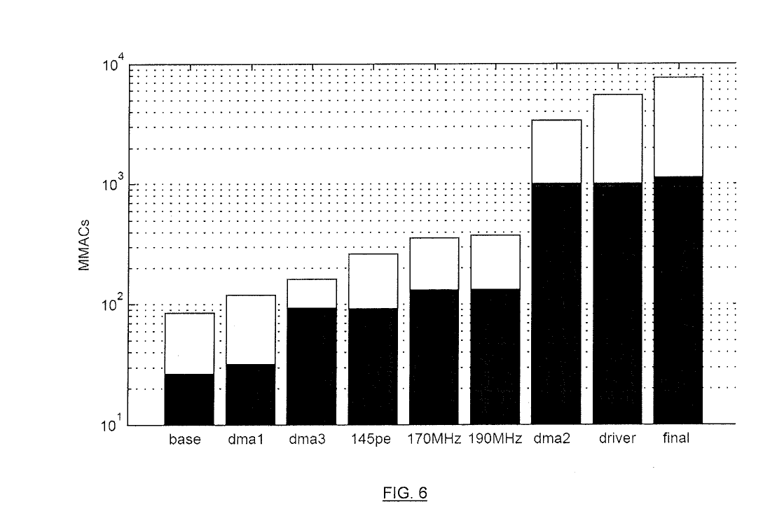

It is important to highlight the incremental optimization steps taken to produce the highest performance from the same hardware available. FIG. 6 shows the effect of revisions on performance, for both minimum and maximum obtained on the data set presented in Table 3.

The base accelerator design is 80 PE, 125 MHz polled MCU I/O system. The final system is 204 PE, 200 MHz, with DMA data-flow. Two key factors play a crucial role in extracting maximum performance: (i) attachment interface, and, (ii) PE placement optimization. Three stages of data-flow—cache prefetch (dma1), stream compute (dma2), and result offload (dma3)—are converted in sequence from polled to burst DMA transfers over on-system PLB bus. While dma1 and dma3 are relatively easy to implement since they require only small additional control hardware to operate the core in-transfer, dma2 requires more careful design and tuning, Converting stream compute data-flow to automatic operation, without MCU control, achieves the most performance improvement as a single optimization step. Bandwidth requirements for compute during DMA stage 2 are similar to cache prefetch. Control bandwidth reduction is attained in dma2 by automating more complicated control in hardware. This reduction is of the same order as the data bandwidth required for the compute operation. It also eliminates MCU cycles required for command computation in driver software—a comparatively slow operation. In general, the attachment interface, whether PLB/AXI/other, and the transfer mechanism by which the data is streamed to the core, may be tailored to a particular hardware appliance where the accelerator is being utilized.

In general, the attachment interface, whether PLB/AXI/other, and the transfer mechanism by which the data is streamed to the core, can be tailored to a particular hardware appliance where the accelerator is being utilized.

Several iterations of frequency improvements provide a marginal effect. Several data reuse enhancements in the block matrix multiplication operation are implemented in the driver. Performance is enhanced when vendor independent code is optimized further in order to enable more efficient mPE to DSP Slice mapping by the synthesizer. An initial 80 PE system is boosted to 204 PEs hitting the resource wall due to auxiliary (MCU/PCIe/MPMC) Slice and BRAM utilization. Virtex 6 and 7 devices provide a greater BRAM to DSP, and Slice to DSP ratios. In these devices, the number of DSP blocks determines placeable PE number, and it is in general significantly larger than in Virtex 5 devices.

Many works, published in literature, present results based on simulations—i.e., no actual implementation is verified nor demonstrated, and no end-to-end system constraints are considered. Not all typical assumptions used for extrapolated performance hold true.

Estimating power consumption of a complex simulated system on FPGA is very difficult, and often not very accurate. Power estimates are further complicated when moving to the board level to provide full system power cost, which is essential for all embedded applications. With a physical implementation, demonstrating true device performance and system power analysis is beneficial.

In this disclosure, a scalable and low-power stream compute accelerator has been presented targeting algorithms based on GEMM operations. A functional stand-aloe prototype, using a mid-range FPGA, is demonstrated to be at par with the performance of a quad core CPU platform of similar vintage. There is an even higher estimated potential for performance when application specific auxiliary computations are performed in-stream with matrix multiplication—an area where highly optimized CPU loses its advantage.

The proposed architecture is believed to demonstrate scalability and is ported into Heterogeneous and Multichip high performance architecture domains for embedded computing. It may provide very fine data parallelism efficiency by allowing cores of different sizes to be instantiated in the same system. Smaller cores may perform small data set computations efficiently, and many of them can be utilized simultaneously for task parallel applications. They may, at run-time, be combined into one large unified core, across multiple cores in the same chip, and across multiple chips implementing the cores, to process very large data and take the advantage of data reuse and performance. Different core-to-core macroarchitecture topologies can be utilized to achieve maximum performance and flexibility on a distributed system level. A benefit demonstrated here is the system's ability to deliver performance at a fraction of the power and energy cost of a similar general purpose system, while offering a path to maintain generality of accelerated computation for a wide range of embedded applications. An embodiment of the described accelerator system is 72× more power efficient at current levels of performance in computation, 36× more energy efficient per unit of computation, and 14× more efficient in full system power consumption in comparison of a PC vs. the described configurable FPGA platform.

The macroarchitecture may include where the heterogeneous/homogeneous cores are in a daisy chain, or a star, or a plurality of other topologies.

Computational accelerator architectures are typically designed for single purpose applications. Some are designed with flexibility or programmability in mind. Some are however locked in a fixed hardware footprint, unable to scale up or down with requirements or application changes.

It may be desirable to create a unified scalable framework and architecture for acceleration of applications based on matrix computation. Below is focused documentation that presents the current unified architecture, performance milestones and results achieved during hardware tuning, and a glance at system level integration.

The architecture is designed based on unified hardware characteristics in small, large and multi-chip environments for implementation to achieve high scalability. Based on the analysis of data handling requirements for various application algorithms (e.g. neural networks), and a review of numerous sample implementations for computation, a data centred approach is selected.

To achieve acceleration in computations, a parallel approach is used. FPGAs provide the necessary resources to achieve high parallelism, quick hardware design to prototype times, and the availability of large and small chips to sample a design's ability to scale.

In matrix computations, large parallelism can be exploited by replicating many homogeneous sequential processing elements. A single processing element may not be difficult to design well. Each, however, has its own data IO requirements that need to be fulfilled to take scalable advantage of inherent parallelism, Large matrix multiplications can be performed with good local data reuse by the processing elements. The architecture's data port can be narrow for this purpose. In small matrix operations, or where the architecture parallelism index is high in comparison to data/computation partitioning, IO requirements can be high. To support high scalability, the architecture is designed around IO to make sure in both cases the efficiency of computation is proportional to available hardware resources.

Requirement analysis, thus, suggests that at the top level, the architecture be specified as a set of IO, required to bring data to the processing elements (PE), and a replicated structure of PEs that handle the data. Ratios can be derived for partitioning hardware resources into sets of ports and PEs, making up processing nodes (or cores). Application flexibility may be achieved with a heterogeneous set cores.

The IO may be modeled with streams—unidirectional single value ports for sequential data transfer. For two parameter matrix computations, three streams are a start. Two input streams, one for each of the computation parameters, and one output stream for the single result. There may be an advantage to performing three parameter matrix computations (general matrix multiplications in Level 3 BLAS of the form D←αAB+βC). A third input stream is not necessary, but beneficial to add to an IO node of the architecture. Not only does it allow smaller architectures without sufficient internal storage resources to add partial results of block matrix operations on the y, but it also allows to compactly partition an algorithm having other operations besides multiplication into uniform dags with high data reuse.

In the architecture details below, the following notations for 10 will be used:
Si—Stream data input for parallel computation (matrix A as above)
Ci—Cache prefetch stream (matrix B)
Bi—Buffer stream used for non-convolutional co-operations
Po—Result (or product) output stream

Streams Si, Ci, and Po are for computation that supports continuous PE operation, Bi is used in cases partial results are saved between operation partitions, or where a third matrix is used in a partition of operations in an algorithm being accelerated. To note, Pi is also an I/O stream used in the architecture. It denotes a pass through of Po results between PEs in a systolic manner. Same applies to Bo and Co.

To explain hardware operation, a simple example will be used, where:

$$A = [ \begin{matrix}1 & 2 \\ 3 & 4\end{matrix} ] ;$$

$$B = [ \begin{matrix}5 & 6 \\ 7 & 8\end{matrix} ]$$

An example bottom up hierarchal view at the architecture follows.

Mini PE (e.g. FIG. 2) is the heart of a processing element which performs computations on incoming streams. It includes of a multiply-accumulate unit (MAC), and data routing based on control configuration to permit a variety of arithmetic operations on the streams. Forward and backward (transpose) matrix operations are supported. So is adding/saving of intermediate results to cache, and vector operations.

For example, to perform D=A×B columns of B are streamed from cache on the Ci input. Rows of A are streamed on the Si input. The result of the MAC, following a row-column dot product, is latched on Po. If D=A×B−C is being performed, C is streamed on Bi, and is loaded to the accumulator ahead of first element products arriving from the multiplier. For operations such as D=A×B^{T}, a shift channel is used where rows of A and columns of B are still streamed in the same order to the miniPE, but the accumulator adds results of the current row/column element product in the current miniPE to the row/column product of a neighbouring PE recursively, with row values streamed over Si being the same for each miniPE. This produces the same result as accumulating locally, but streaming B in row order. Allowing the same stream sequence for both transpose and non-transpose operations keeps associated data memory access capable of efficient block bursts.

All connections in this and following figures are buses that are n bits wide, and represent a single number with appropriate integer and fractional precision that add up to n bits. The implementation may support both fixed and floating point numbers.

The processing element combines a miniPE and local cache to be able to perform standalone operations and load/store from cache. It includes stream shifter components at this level as well. FIG. 3 has the details. Stream shifters are a part of a greater systolic dataflow architecture as demonstrated herein. The shifter for Bi stream is combined to perform both auxiliary parameter input and product result offload, Auxiliary parameter matrix (C) stream is loaded into Bi input. At the same cycle as the stream load is finished, completed product results from Po of miniPE are latched onto the same shift elements. As Bi is loaded with the next data sequence, results Po are shifted out using the Bo output.

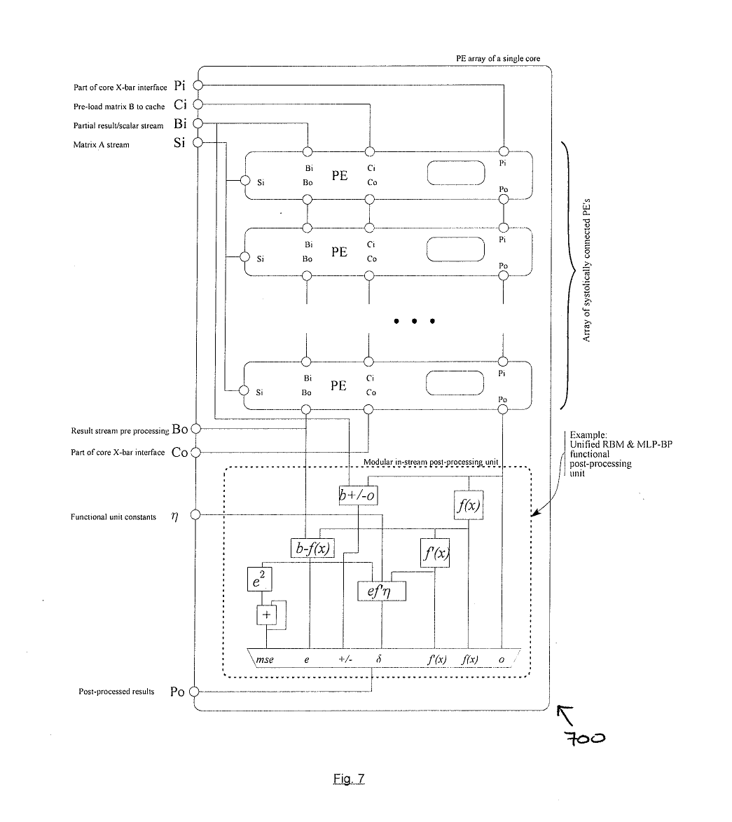

The stream core consists of an array of PEs connected in a systolic architecture with data streams. A functional block is used at the tail of the PE array to enable post-processing the data in-stream. It allows vector and scalar operations on the entire stream in parallel with matrix operations moving through the PEs, thus enabling a substantial performance benefit by co-executing vector and matrix operations together. A neural network functional block 700 is demonstrated in FIG. 7 for reference.

In cases allowing for run time reconfiguration, such as on FPGAs or hybrid fixed and reconfigurable silicon architectures, the functional block that performs the post-processing may be a run-time reconfigurable element, able to be changed at run-time, infrequently, or at each operation performed on the core, to suit the needs of the computation being performed.

In implementations allowing for run time reconfiguration, such as on FPGAs or hybrid fixed+reconfigurable silicon architectures, the functional block that performs the post-processing can be a run-time reconfigurable element, able to be changed at run-time, infrequently, or at each operation performed on the core, to suit the needs of the computation being performed.

In a core having two or more PE's, with matrices as defined herein, each processing element will perform the computations for one row/column dot product. The core operates in the following fashion:
5 and 6 are preloaded onto Ci in 2 cycles and are latched into caches at offset 0;
7 and 8 are preloaded onto Ci in 2 cycles and are latched into caches at offset 1;
PE₀ contains the first column of matrix B, with elements 5 and 7, and PE₁ now contains second column with elements 6 and 8;
Row 0 of A is streamed, one value at a time, 1 then 2, onto Si. In 2 cycles (plus latency) PE₀ produces row 0 column 0 result for the product matrix, and PE₁ the result for row 0 column 1.
The cycle repeats by presenting row 1 of A onto Si, values 3 and 4, while PE's compute row 1 locations of the result matrix. The results of the previous computation move down the Bi shift stream to appear at Po of the core after they pass through the systolic array.

For the product of D=A×B^{T}, the following are the steps:
5 and 6 are preloaded onto Ci in 2 cycles and are latched into caches at offset 0;
7 and 8 are preloaded onto Ci in 2 cycles and are latched into caches at offset 1;
PE₀ contains the first column of matrix B, with elements 5 and 7, and PE₁ now contains second column with elements 6 and 8;
Row 0 of A is streamed, one value at a time, 1 then 2, onto Bi;
Instead of PE₀ calculating 1×5+2×7 in one node, PE₀ now calculates only multiples of 1. Partial result 1×5 is sent to PE₁, while 2×8 is sent to PE₀ in a shift operation.
PE₀ then performs 1×7 and adds it to 2×8 received. PE₁ performs 2×6 and adds it to 1×5 received from PE₀ in previous cycle.
The operation repeats with second row of A streamed to Bi, while results of previous operation are
shifted down the same stream to output. This can temporally coincide with the calculation of another value by PEs.

For this operation, there is cache addressing control, as each processing element needs to access an offset column element and shift the partial result at each step. This way, the same matrix in the cache can be operated on in transpose or original order without cache re-load.

Alternatively, cache preload can occur in reverse addressing order. Cache preload frames of rows of matrix B can be streamed to Ci in the same order. The individual caches will operate in write mode one at a time, each saving a row of B from the sequential stream. This is in contrast to the row being latched on the stream shifter after a number of shift-in cycles, and each cache writing one index of a row simultaneously in one cycle, from a sequence of rows being streamed. This method, however, may not allow for several smaller matrices to remain in the caches and operations in either transpose or original order be performed one after the other, as in forward and back propagation of neural networks. An offload/reload is used in this case.

Each accelerator core includes of one PE array, and has one set of independent streams—the basic set of 3 or 4. Due to the stream nature of the IO, the cores can be connected in a pipe using crossbars, thus extending the processing capabilities. Large datasets can be processed using a single IO stream injector, and a series of cores. Data reuse is maximized in this instance, and IO requirements are low. Small datasets can be processed in parallel on separate cores using the individual IO stream injectors, as IO requirements for operations where data reuse is low are higher.

While a large, united core with a single stream injector can perform large block matrix operations efficiently, many stream injectors may be needed to perform small matrix or small block operations without stalls due to data deficit at PEs. Alternatively, with multiple stream injectors, a large matrix computation can be divided into smaller blocks, and these be assigned to the smaller individual cores. The choice depends on the availability of stream injectors, the size of individual cores, and the matrix dimensions.

In some cases, there is provided a systolic compute accelerator architecture for matrix multiplication (as subset hardware in computing a variety of other algorithms, which may be considered as a second generation of the machine learning accelerator). The systolic compute architecture itself, for example, how and why the PE's are connected, is intended to provide a benefit.

Further, the properties of the systolic array are intended to allow for an advantageous interconnect structure (in single core and multicore configurations). The simple I/O interface is intended to save bandwidth, boost performance.

The interface can consist at the minimum of 1 input and 1 output ports (or 1 bi-directional port) with adapters to the 4 communication streams described in the diagrams and text. Overall, this interface is intended to allow for high core performance with minimal, and very optimal, bandwidth requirements to support this computation performance. This implementation is further intended to allow for the system to have efficient multicore/multichip configurations.

Further, there is provided a multicore/multichip capability as shown in FIG. 8, and a method for use which is intended to provide optimal performance and efficiency. The multicore/multichip property of the hardware is enabled by the IO and the systolic architecture as given.

The application specific engine is intended to allow for in-stream computations of a variety of functions without loss of time and with minimal hardware added, as described herein with reference to Z=αXY+βW. Further, it is intended that accelerator+ASE allows for Z=f(αXŶ(T)+βW). ASE can accomplish a wide range of f( ) on the final results of the matrix operations, in-stream without the need to separately funnel the data through a different hardware block a second time. It will be understood that the hardware can be designed as appropriate to facilitate a multitude of in-stream functions.

There is further provided for specific hardware components in the PE and mPE that allow for “on the fly” transverse operand operations. There are components of mPE that allow on the fly transpose of operations (the optional T) in Z=f(αXŶ(T)+βW) which is intended to allow for Z=XY, or Z=XŶT, without having to reorder the matrices in memory, or pre-loaded matrices in the caches of the core. This is intended to save a step, especially when performing operations on same matrices multiple times, one as Z1=XY, the next as Z2=Z1ŶT etc.

Further, to explain hardware operation, an simple example is detailed herein, where:

$$X = [ \begin{matrix}{x}_{1 , 1} & {x}_{1 , 2} \\ {x}_{2 , 1} & {x}_{2 , 2}\end{matrix} ] ;$$

$$Y = [ \begin{matrix}{y}_{1 , 1} & {y}_{1 , 2} \\ {y}_{2 , 1} & {y}_{2 , 2}\end{matrix} ] ;$$

$$Z = [ \begin{matrix}{z}_{1 , 1} & {z}_{1 , 2} \\ {z}_{2 , 1} & {z}_{2 , 2}\end{matrix} ]$$

y_{1,1} and y_{1,2} are preloaded using Ci in 2 cycles and are latched into caches at offset 1;
y_{2,1} and y_{2,2} are preloaded onto Ci in 2 cycle and are latched into cache at offset 2;
PE₀ contains the first column of matrix Y, with elements y_{1,1} and y_{2,1}, and PE₁ now contains second column with elements y_{1,2} and y_{2,2};
First row of X is streamed, one value at a time, x_{1,1} then x_{1,2}, onto Si. In 2 cycles (plus latency) PE₀ produces row z_{1,1} of the product matrix z, and PE₁ the result for z_{1,2}.
The cycle repeats by presenting x_{2,V} onto Si, while PE's compute row z_{2,V}. The results of the previous computation move down the Bi shift stream to appear at Po of the core after they pass through the systolic array
F the product of Z=X×Y^{T}, the following are the steps:
y_{1,1} and y_{2,1} are preloaded using Ci in 2 cycles and are latched into caches at offset 1;
y_{1,1} and y_{2,2} are preloaded onto Ci in 2 cycles and are latched into caches at offset 2;
PE₀ contains the first column of matrix Y, with elements y_{1,1} and y_{2,1}, and PE₁ now contains second column with elements y_{1,2} and y_{2,2};
First row of X is streamed, one value at a time, x_{1,1} then x_{1,2}, onto Bi.
Instead of PE₀ calculating x_{1,1}×y_{1,1}+x_{1,2}×y_{2,1} in one node. PE's now accumulate an offset index. Partial result x_{1,1}×y_{1,1} is sent to PE₁, while x_{1,2}×y_{1,2} is sent to PE₀ from PE₁ in a shift operation.
PE₀ then performs x_{1,1}×y_{2,1} and adds it to x_{1,2}×y_{2,2} received in the next cycle. PE₁ performs x_{1,2}×y_{1,2} and adds it to x_{1,1}×y_{1,2} received from PE₀ previously.
The operation repeats with second row of X streamed and held on Bi, while results of previous operation are shifted down the same stream to output. This can temporally coincide with the calculation of another operation using results Z shifted to down-stream PEs on B stream simultaneously.

For this operation, careful cache addressing control is necessary, as each processing element needs to access an offset column element and shift the partial result at each step. This way, the same matrix in the cache can be operated on in transpose or original order without cache re-load.

Alternatively, cache preload can occur in reverse addressing order. Cache preload frames of rows of matrix Y can be streamed to Ci in the same row-order. The individual caches may operate in write mode one frame-cache pair at a time, each saving a row of Y from the sequential stream. This is in contrast to the row being latched on the stream shifter after a number of shift-in cycles, and each cache writing one index of a row simultaneously in one cycle, from a sequence of rows being streamed. This method, however, does not allow for several smaller matrices to remain in the caches and operations in either transpose or original order be performed one after the other, as in forward and back propagation of neural networks, An offload/reload is required.

When Y can fit entirely into cache, the result of the matrix computation and the weight cache can be reused without transposing the content. Z can then transferred to stream Bi or directly into cache to continue computation at the next step without a costly store/reload operation with external memory. The product can then multiplied by the same operands, already loaded in the core, in forward or reverse order.

Double and shift buffering applies to, for example, Z=X×Y.

Double buffering may be used when Y does not fit entirely into cache. Cache (Y carrying portion) is split in half. One half for stream computation, second half for double buffer of cache refresh windows. As computation proceeds on first half of Y, new blocks of Y are pre-loaded into cache. Computation stops at partial products of Z, and continues directly using a new portion of cache without the need to offload the partial products to external memory, and then read them back.

Shift buffering may be used to save the space of cache when Y does not entirely fit into cache. As computation progresses, each row in streamed X windows is shifted by one element down, as one row of Y in cache is updated at a time. Effectively when A is shifted fully into the next window, Y is aligned with the next window, and the process can repeat from the start. Number of X vectors must equal the depth of Y cache blocks. Shift-buffering effectively doubles the depth and possible data reuse of Y cache blocks vs. double buffering.

Stream input is synthesized with fixed width, with width selected optimally from the perspective of external memory storage holding X and Y data. Input data can be truncated to a limited precision thus allowing for compression of elements, specifically of Y. This allows multiple elements of Y to be sent in parallel on the same wide stream bus, allowing to perform a different degree-dimension of parallelism via software control.

In an example, the user interface on the PC is based on a Matlab function that activates a command line utility (compiled with the driver) to perform data transfers between PC and board. The intermediate storage medium is data files on disk. The performance of this mechanism is approximately 10 Mb/s. It typically takes 10% of total processing time to read and write input and output files for single matrix operations. This impact may increase as the speed of FPGA computation is improved. This impact may also decrease as the accelerator is programmed to handle more stand-alone operations, such as those of a multi-epoch neural network training sequence.

Two alternatives exist:
add shared memory resources between Matlab and driver software
create a ram disk for quick file operations
moving to stack based data flow

In some cases, tying driver software to a Matlab implementation will require potentially significant effort in creating a synergy between the two using a shared memory interface.

It is intended that very little effort will be required to insert a ram disk into the flow. This is the best short-term solution to improving the PC-board communication. It is also reasonable in terms of performance vs. effort based on the reduced significance for complicated computation based on NN algorithms.

Moving to a TCP/IP stacked architecture is intended to bring performance somewhere between a ram disk and shared memory access, and may also required medium effort to implement on both sides (Matlab and driver). This may also be portable solution. A PC with the board can be disconnected from the UI. The UI can then be located anywhere on the internet and feed data for computation remotely.

Because the current PCIe interface and driver software is capable of moving data to the board and back at 40 Mb/s (250 Mb/s is the actual 1× link speed), the board can be removed from the PC and plugged into a local ethernet configuration. A GigE connection can feed 100 Mb/s of data to the board. Both the PC and the board are fully capable of these speeds. This functionality is intended to allow experiments with clusters of boards connected as compute nodes requiring no PCs. With the TCP/IP dataflow moved from PC PCIe driver to the board directly, improved portability and usability of a system incorporating one or more boards in an accelerator node can be tested. Substantially reduced power requirements can also be demonstrated in a very convincing way. GigE data source devices are already gaining significant popularity (such as network connected GigE cameras). This is further intended to allow interesting configurations to be documented, such as where a continuous data stream comes from a local network attached or remote device, and general system control and result stream display is done on a hand-held portable device (such as a tablet or wifi enabled mobile phone), removing the need for power hungry PCs all together.

Currently used board memory has 3.2 Gb/s throughput. The memory controller has 8 ports programmable with a variety of protocols available. It is limited in the application of this architecture to resource consumption by the extra ports, reducing the number of PEs implementable on the chip.

Current PLB bus DMA transfers can achieve 200 Mb/s (verified on board) burst performance per 200 MHz bus, Performance increases linearly as bus frequency increases, although MicroBlaze does not support more than 200 MHz operation. Standard available DMA controllers for PLB bus from Xilinx are only 32 bit devices not capable of write-through operation. Current MicroBlaze transfer operations are at 7 Mb/s.

A point to point 64 bit LocalLink interface can achieve upwards of 800 Mb/s, using 4 ports of which would saturate the memory bandwidth. LocalLink has is functionally verified using 32 bit 100 MHz interface to provide about 200 Mb/s bandwidth.

The new Virtex 6 and 7 devices from Xilinx, and the associated ISE 12 and 13 toolchain provide support for a new bus interface standard—AXI, used in the newly developed ARM hardened cores FPGA architectures in those devices. The basic AXI interface provides many features compatible with data streaming. The DMA controllers available are capable of achieving 1000+Mb/s throughput per interface.

In the preceding description, for purposes of explanation, numerous details are set forth in order to provide a thorough understanding of the embodiments. However, it will be apparent to one skilled in the art that these specific details may not be required. In other instances, well-known structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

TABLE 1
Naming convention

| | Hardware Port | Corresponding Operand |
|---|---|---|
| C | Cache prefetch stream | Y |
| S | Compute stream | X |
| B | Auxiliary stream | α, β, W, Z′ |
| P | Result stream | Z, Z′ |
| i | Designates input | |
| o | Designates output | |

TABLE 2
Power consumption, FPGA vs. PC

| | FPGA | PC | Δ |
|---|---|---|---|
| Idle when configuring | 5.70 W | 117.4 W | 21X |
| Idle (configured) | 10.26 W | 117.4 W | 11X |
| uBlaze running, core idle | 10.40 W | 117.4 W | 11X |
| Computation (system total) | 11.07 W | 164.8 W | 14X |
| Overhead cost | 10.4 W | 117.4 W | 11X |
| Computation cost | 0.66 W | 47.4 W | 72X |
| Energy adjusted (J/GMAC) | 0.101 | 3.62 | 36X |

TABLE 3
FGPA accelerator performance vs. high-end quad core PC

| | | PC | FPGA | FPGA | FPGA | System | PC | FPGA | PC |
|---|---|---|---|---|---|---|---|---|---|
| Matrix | Ops | time | compute | sytem | core | to core | perf | perf | vs. |
| Size | (MMACs) | (s) | time (s) | cycles | cycles | ratio | (GMACs) | (GMACs) | FPGA |
| 4096 × 4096 | 68.700 | 5.25 | 12.7 | 2.53G | 491M | 5.15 | 13.1 | 5.43 | 2.4× |
| 2048 × 2048 | 8.500 | 0.704 | 1.65 | 328M | 63.9M | 5.13 | 12.1 | 5.22 | 2.3× |
| 1024 × 1024 | 1.070 | 0.120 | 0.221 | 44M | 8.62M | 5.10 | 8.91 | 4.86 | 1.8× |
| 512 × 512 | 134 | 0.0235 | 0.0383 | 7.6M | 1.37M | 5.54 | 5.70 | 3.50 | 1.62× |
| 128 × 128 | 2.1 | 0.00081 | 0.00207 | 415k | 59k | 7.03 | 2.59 | 1.01 | 2.56× |
| 4080 × 1024 | 17.045 | 1.403 | 2.629 | 526M | 105M | 5.00 | 12.1 | 6.48 | 1.87× |
| 204 × 1024 | 42.6 | 0.0076 | 0.0121 | 460M | 2.4M | 5.21 | 5.58 | 3.5 | 1.59× |

TABLE 4
Resource utilization

| | | | | | Available on |
|---|---|---|---|---|---|
| | PE | Core | System | Util'n | XC5VSX50 |
| LUTs | 51 | 10,472 | 23,767 | 73% | 32,640 |
| FFs | 34 | 7,079 | 19,947 | 61% | 32,640 |
| Slices | 68 | 3,497 | 7,910 | 97% | 8,160 |
| BRAM | 0,5 | 102 | 132 | 100% | 132 |
| DSP | 1 | 204 | 207 | 79% | 288 |

1. A hardware accelerator system as generally and specifically detailed herein.

2. A hardware accelerator method as generally and specifically detailed herein.
